(19) United States
(12) Patent Application Publication
(10) Pub. No.: US 2006/0103968 A1
(43) Pub. Date: May 18, 2006

(54) Dynamic skew compensation systems and associated methods

(76) Inventor: Joe K. Jurneke, Brighton, CO (US)

Correspondence Address: MORRISON & FOERSTER LLP, 755 PAGE MILL RD, PALO ALTO, CA, 94304-1018, US

(21) Appl. No.: 10/986,748

(22) Filed: Nov. 12, 2004

(51) Int. Cl. G11B 20/20; G11B 5/584

(52) U.S. Cl. 360/76; 360/77.12

(57) ABSTRACT

In one example, a system for positioning a transducer head to a storage medium is provided. The system includes a transducer head assembly including read/write elements, at least one actuator for adjusting the azimuth position of the transducer head, first and second position sensors, and a controller. The first and second sensors sense a reference associated with a position of the storage medium, where the first and second sensors are positioned on opposite sides of the read/write elements of the transducer head along a direction of storage medium transport. The controller adjusts the azimuth position of the transducer head in response to sensed positions of the reference by the first and second sensors. The at least one actuator may include differential actuators. The adjustments to the transducer head may be made dynamically during reading and writing operations.

### BACKGROUND

1. Field of the Invention

The invention relates generally to flexible media data storage devices and systems, and more particularly to methods and systems for head positioning servo systems for detecting and/or adjusting for misalignment between a read/write head and a flexible media system comprised of either magnetic or optical tape, either singularly or in combination.

2. Description of the Related Art

Digital data-recording on tape remains a viable solution for storage of large amounts of data. Conventionally, at least two approaches are employed for recording digital information onto magnetic or optical recording tape. One approach calls for moving a recording medium past a rotating head structure that reads and writes user information from discontinuous transverse tracks. Interactive servo systems are typically employed to synchronize rotation of the head structure with travel of the medium. This method is generally referred to as “Helical Recording.” Another approach is to draw the recording medium across a non-rotating head at a considerable linear velocity. This approach is sometimes referred to as longitudinal recording and playback.

Increased data storage capacity, and retrieval performance, is desired of all commercially viable mass storage devices and media. In the case of linear tape recording a popular trend is toward multi-channel movable head structures with narrowed recording track widths and read track widths so that many linear data tracks may be achieved on a recording medium of a predetermined width, such as one-half inch width tape. To increase the storage density for a given cartridge size the bits on the medium may be written to smaller areas and on a plurality of parallel longitudinal tracks.

As more data tracks are recorded on a tape, each track becomes increasingly narrow and more susceptible to errors caused by, for example, misalignment or misorientation of the head to the data tracks. One exemplary limiting problem of track density includes tape skew (or slope of the tape) with respect to a centerline of the tape head. For example, the storage tape is generally allowed to move perpendicular or laterally to the direction of tape motion. This lateral motion is due, at least in part, from tape path tolerances and tape dimensional variations built into the drive. Examples of tolerances that allow for lateral tape motion include the cartridge reel height, take-up reel height, guide heights (each of which includes its own tolerances), tape guide flange-to-flange spacing, take-up and supply reel flange-to-flange spacing, non co-planarity between supply reel, tape path components and take-up reel, and tape width variations. Further, because tape is generally read and written by the tape head in both directions the skew may vary with direction.

Tolerances allowing for lateral tape motion may result in the tape entering the last guide prior to the head at a relatively high level and leaving the first guide after the head at a relatively low level, which would lead to skew of the tape with respect to the head. Similarly, the opposite condition can occur in that the tape may enter the guide prior to the head low and exit the guide after the head high. Tape skew results in the slope of the tape edge (and data tracks stored thereon) to be non-perpendicular relative to the centerline of the tape head. Additionally, in a serpentine longitudinal recorder, the centerline of the read track is not centered on the written track in the presence of skew. FIG. 1 illustrates an exemplary tape drive experiencing tape skew relative to the tape head. The scale of the drawing and degree of tape skew between adjacent guides is exaggerated to better illustrate the resulting misalignment or offset of the read and write elements of the head to a data track on the tape due to the tape skew.

During writing operations, for example, separate electronic channels allow for simultaneous read and write operations to a particular data track. Simultaneous read and write operations are used generally to immediately confirm the correct storage of data on the tape, e.g., indicating whether storage was successful. Tape skew may limit the ability for read-after-write verification of data for given data track and read/write element dimensions because the read element may not be aligned with the data track written by the write elements as shown in FIG. 1. Generally, to compensate for tape skew, the width of data tracks are written with sufficient width such that the read head will be on track during the maximum expected tape skew events. Writing the tracks with sufficient width to compensate for tape skew, however, generally decreases the density of data tracks for a given tape width and correspondingly decreases the storage capacity. Accordingly, tape skew can limit the track density for a given size storage tape.

### BRIEF SUMMARY

According to one aspect of the present invention position sensing systems and methods, including dynamic skew compensation systems and methods, are provided.

In one example, a read/write head positioning system to compensate for skew of a storage medium includes a transducer head assembly including read and write elements, at least one actuator for adjusting the azimuth position of the transducer head, first and second position sensors, and a controller. The first and second sensors sense a reference associated with a position of the storage medium, where the first sensor and the second sensors are positioned on opposite sides of a centerline of the read and write elements of the transducer head along a direction of storage medium transport. The sensed positions of the reference on opposite sides of the read and write elements may indicate the relative slope or skew of the storage medium and data tracks thereon to the transducer head. The controller adjusts the azimuth position of the transducer head in response to sensed positions of the reference by the first and second sensors. In one example, adjustments to the transducer head are made dynamically, e.g., on the fly, during reading and writing operations. Further, the reference associated with the position of the storage medium may include one or more edges of the storage medium, a magnetically and/or optically detectable feature of the storage medium, or the like. When edge damage, or defects in a magnetic or optical pattern sensed for skew determination are present, a means may be provided through correlation of the two or more sensors to remove the effects of said damage or defects from generating a skew error where one would not normally be present.

In one example, the head is adjusted by differential actuators, e.g., piezoelectric actuators, which rotate the transducer head around its center of mass. Additionally, the sensors may include optical and/or magnetic sensor and may be positioned adjacent guide elements of a drive on opposite sides of the transducer head.

In another example, a method for detecting the position of a transducer head with respect to a storage medium includes sensing a reference associated with a position of a storage medium at a first position along a direction of storage medium transport, sensing the reference associated with the position of the storage medium at a second position along the direction of storage medium transport, wherein the first position and the second position are on opposite sides of a transducer head along a direction of storage medium transport, and positioning the azimuth of the transducer head relative to the storage medium in response to the sensed first position and the second position of the reference. The transducer head may be positioned dynamically during read and write operations. In one example, repositioning includes activating differential actuators to adjust the azimuth of the transducer head. The differential actuators may include piezoelectric devices.

In another example, use of track following sensors placed within the head structure, on opposite sides of the head structure centerline, normally used to sense tracking error, can be used to sense presence of skew and provide appropriate action to correct skew conditions.

The present invention and its various embodiments are better understood upon consideration of the detailed description below in conjunction with the accompanying drawings and claims.

### BRIEF DESCRIPTION OF DRAWINGS

FIG. 1 illustrates an exemplary tape head for which the storage tape is experiencing skew relative to the drive head;

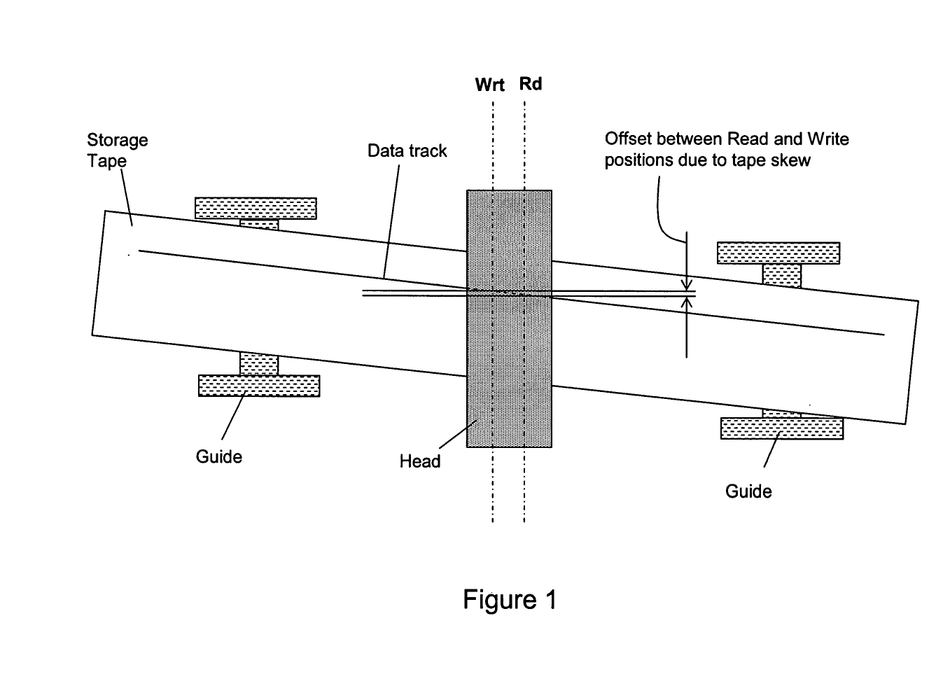

FIG. 2 illustrates an exemplary tape drive including a position sensing system according to one example;

FIG. 3 illustrates a perspective view of an exemplary position sensing system;

FIG. 4 illustrates an exemplary head assembly and position sensing system including tape edge sensors;

FIGS. 5A and 5B illustrate operation of exemplary differential actuators for a read/write head assembly;

FIGS. 6A and 6B illustrate operation of an exemplary actuator for a read/write head assembly;

FIG. 7 illustrates an exemplary head assembly and position sensing system including tape edge sensors; and

FIG. 8 illustrates an exemplary head assembly and position sensing system including reference track sensors.

### DETAILED DESCRIPTION

Various methods and systems for detecting and/or adjusting for tape skew relative to a tape head are provided. The following description is presented to enable a person of ordinary skill in the art to make and use various aspects of the inventions. Descriptions of specific materials, techniques, and applications are provided only as examples. Various modifications to the examples described herein will be readily apparent to those skilled in the art, and the general principles defined herein may be applied to other examples and applications without departing from the spirit and scope of the inventions.

Accurately positioning a transducer head with respect to a magnetic storage tape in a tape drive system during writing and reading processes is one of the main challenges in the area of magnetic storage tape systems. Generally, a closed loop servo system, deployed by the tape drive electromechanical system, utilizes an estimate of the head's position relative to the storage tape to align the transducer head to a data track position. Exemplary methods and systems described below gather positional information for the relative positioning of transducer elements to the magnetic storage tape by sensing the position of the magnetic storage tape on opposite sides of the magnetic head, e.g., before and after the head along the tape path. Additionally, the position of the tape edge on each side of the magnetic head along the tape path or direction of tape transport may be used to determine the relative slope or skew of the tape to the magnetic head.

In one example, a tape edge sensor, e.g., optical or magnetic, is positioned adjacent guide members on each side of the magnetic head to monitor movement in one or both edges of the tape thereby allowing for the computation of tape skew relative to the tape head. The skew is determined between the two guides to generate a correction for the servo system. The system may adjust differential actuators associated with the head carriage assembly to rotate the head carriage assembly about the center of gravity to change the azimuth of the tape head and align read/write elements with data tracks of the storage tape, thereby reducing errors associated with tape skew. Adjustments may be dynamic, i.e., performed on the fly during reading and writing processes. As the skew varies, one of the differential actuators may grow in height while the other collapses, thereby tilting the head carriage assembly about its center of axis in the appropriate direction without shifting the centerline of the head assembly.

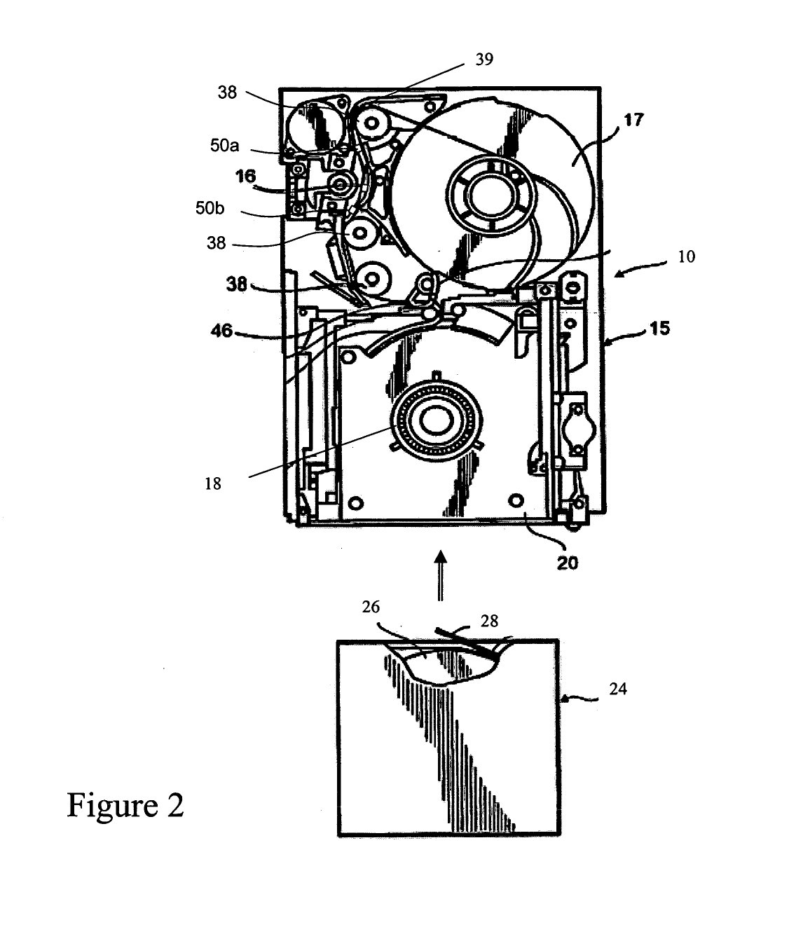

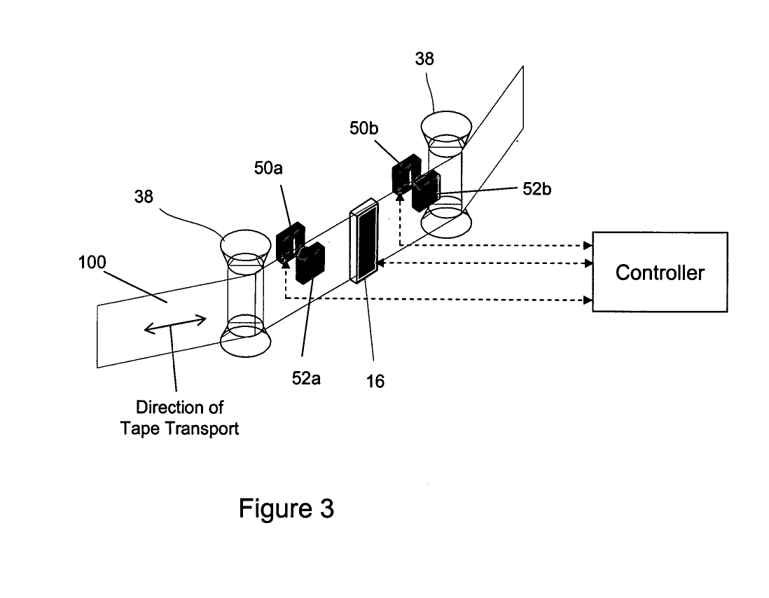

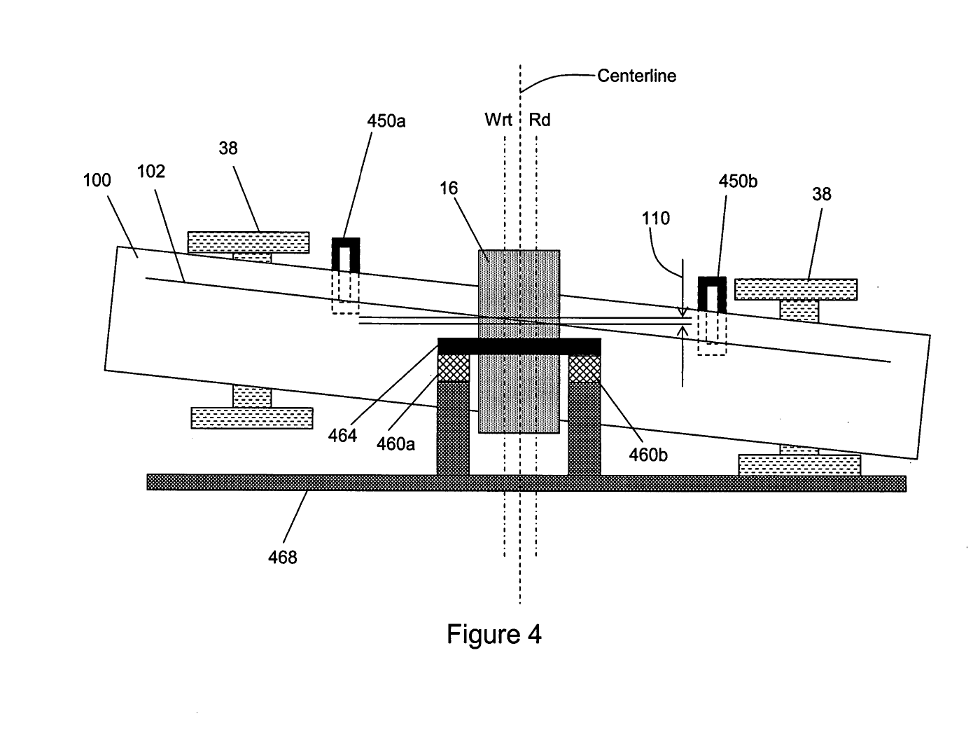

Referring initially to FIG. 2, an exemplary tape drive 10 is illustrated that may include an exemplary position sensing system to sense and compensate for tape skew. The exemplary servo system may include sensors 50a and 50b to sense one or more references associated with the storage tape 28 and adjust the position of head 16 accordingly as described in greater detail with respect to FIGS. 3 and 4. Tape drive 10 includes a tape drive housing 15, a data transducer, i.e., read and/or write head 16, a take-up reel 17, and a receiver 20. Tape drive 10 is used in conjunction with a cartridge 24 which houses a storage tape 28 on supply reel 26. Receiver slot 20 is configured to receive a suitable cartridge 24 therein adjacent reel driver 18. Tape drive 10 may also include a door and various mechanisms for receiving and ejecting cartridge 24. When cartridge 24 is received in receiver slot 20 a buckler motor 46 or the like may engage a cartridge leader and stream storage tape 28 along a tape path within tape drive 10 passing read/write head 16 and onto take-up reel 17. The tape path may include various tape guides 39, rollers 38, one or more read/write heads 16, compliant guides, hydrodynamic or hydrostatic guide elements (not shown), and the like before being wound upon take-up reel 17.

Exemplary tape drive 10 used in conjunction with cartridge 24 is illustrative only and those of ordinary skill in the art will recognize that various other storage media systems and devices may be used. For example, the systems and methods for detecting and adjusting for tape skew apply to magnetic or optical storage devices such as open reel, pancake, cassette, cartridge, or other physical embodiments utilized to hold, contain, or manage recording media (such as floppy disk, “big box” tape, 9840, magstar MP, etc.).

Tape drive 10 is typically installed within or associated with a computer (not shown) or computer network (but may alternatively be part of a data logger from satellite downlink, for example). Additionally, tape drive 10 may be used as part of an automated tape library having a plurality of tape cartridges and a robotic transfer mechanism to transport cartridges to one or more tape drives. An exemplary storage library is described in U.S. Pat. No. 5,760,995, entitled “MULTI-DRIVE, MULTI-MAGAZINE MASS STORAGE AND RETRIEVAL UNIT FOR TAPE CARTRIDGES,” which is hereby incorporated by reference in its entirety.

Cartridge 24 generally includes a substantially rectangular cartridge housing which encloses cartridge reel 26 and storage tape 28. In other examples, a housing (if included) could be other shapes such as round for open reel tape. Cartridge 24 may further include a cartridge door to protect storage tape 28 therein and a cartridge leader (not shown), which is exposed when the door is open. Storage tape 28 stores information in a form, e.g., digital, that may be subsequently retrieved if desired. Storage tape 28 may be approximately one-half inch in width, but larger and smaller widths are contemplated, e.g., 4-8 mm, 19 mm, etc. Storage tape 28 may have a thickness of approximately 0.5 mils (0.0005 inch), but thinner or thicker tapes are possible. Typically, storage tape 28 includes a storage surface on one or more sides of storage tape 28 that may be divided into a plurality of parallel tracks along the length of storage tape 28. Alternatively, the data may be recorded in diagonal strips across storage tape 28.

Various other features of a tape drive may be included, for example, various buckler systems, rollers, tape guides, receiving mechanisms, dampers, winding mechanisms, and the like may be used. Exemplary tape drive systems and methods that may be used with the various exemplary systems and methods described, include, for example, those described in U.S. Pat. Nos. 6,246,535, 6,108,159, and 5,371,638, and U.S. patent application Ser. No. 09/865,215, all of which are hereby incorporated by reference as if fully set forth herein. Those of ordinary skill in the art will recognize that various other suitable tape drive systems and servo systems (perhaps with some modification that will be apparent to those of ordinary skill in the art) may also be used with one or more of the exemplary systems and methods.

FIG. 3 illustrates a perspective view of an exemplary servo system for sensing and compensating for tape skew, the system including a head 16 and position sensors 50a and 50b. Head 16 and position sensor 50a and 50b are shown without accompanying support structures, such as a head assembly or actuators for illustrative purposes. Additionally, a controller, e.g., the drive controller, controls the relative position of head 16 in response to, at least in part, signals from position sensors 50a and 50b associated with the position of tape 100 on either side of head 16. The position of tape 100 on either side of head 16 may be used to determine the skew or slope of tape 100 relative to head 16.

As shown, tape 100 is guided by rollers 38 (or other guiding structures) positioned on either side of head 16. Positioned adjacent, and on either side of head 16, are position sensors 50a and 50b used to detect a reference associated with the relative position of the storage tape, e.g., a tape edge, magnetic/optical servo track, or the like. In this particular example, position sensors 50a and 50b are positioned to detect the edge of tape 100 before and after streaming by head 16. In other examples, position sensors may include magnetic or optical devices for detecting the relative positions of a reference associated with the storage tape. For example, a data track or reference track stored magnetically and/or optically on storage tape 100 may be used to determine skew of tape 100 as it passes head 16.

In this example, position sensors 50a and 50b detect the position of the edge of tape 100 and the slope or skew of the tape as it passes by head 16 may be computed. A controller may adjust the tilt or azimuth position of head 16 and read/write elements associated with head 16 to more accurately read and/or write to data tracks of tape 100 in response to the sensed positions. In one example, described in greater detail with respect to FIG. 4, differential actuators associated with head 16 are used to rotate head 16 about the center of mass of head 16 to compensate for tape skew. Correction and accommodation may be provided for conditions of tape edge damage and/or magnetic/optical track damage that would otherwise generate a skew error where one does not exist.

In one example, position sensors 50a and 50b include optical sensors, e.g., CCD or CMOS sensors, light transmission sensors, or the like for detecting an edge of storage tape 100. Light sources 52a and 52b may be used to illuminate and image the edge of tape 100. Alternatively, light source 52a and 52b may be positioned on the same side as sensors 50a and 50b or be omitted. In other examples position sensors 50a and 50b may include magnetic sensors or other track following optical sensors as are known in the art. Further, position sensors 50a and 50b may be positioned to detect the top edge of tape 100, the bottom edge of tape 100, opposing edges of tape 100, or position error between sensors as in the case of utilizing track following sensors on opposite sides of head centerline for skew detection. Detecting both edges of tape 100 may allow for the determination of tape irregularities, e.g., damage or irregularities in the tape edge or width, which do not contribute to tape skew, or increase robustness of the system with regard to correlation of defects and offsets. Any number of edge sensors may be used to detect the position of one or both edges of tape 100. Additionally, a position sensor 50a or 50b may be positioned or configured to simultaneously detect both the top and bottom edge of tape 100, which may further allow the controller to determine tape irregularities, e.g., damage or irregularities in the tape edge or width.

In one example, light sources 52a and 52b include one or more coherent light sources, e.g., a laser diode or the like. Additional masks, optical elements, or filters may be used within the light path between light sources 52a and 52b as will be recognized by those of ordinary skill in the art. For example, various filters, lenses, prisms, masks, and the like may be used. Additionally, light sources 52a and 52b may emit various electromagnetic radiation and are not limited to visible light; for example, light sources 52a and 52b may emit ultraviolet or infrared light. Position sensors 50a and 50b, light sources 52a and 52b (if included), may be mechanically fixed in a known physical relationship relative to the drive base and/or the head assembly (not shown).

A controller associated with the drive receives signals from the position sensors 50a and 50b indicating relative positions of the magnetic storage tape 100 along the tape path before and after head 16. The controller may determine the relative skew of tape 100 to head 16 and control one or more actuators (not shown) to move head 16 to compensate for varying tape skew.

FIG. 4 illustrates a side view of exemplary positioning system including position sensors and differential actuators for the head assembly to detect and compensate for tape skew. As shown, tape 100 is sloped between adjacent guide rollers 38 on either side of head 16. Further, the slope or skew of tape 100 results in an offset 110 between the write (“Wrt”) and read (“Rd”) elements of head 16. In this example, the head assembly mount 464, which positions head 16 relative to tape 100 includes differential actuators 460a and 460b positioned on base plate 468. In one example, differential actuators 460a and 460b include piezoelectric actuators, which may contract or expand in response to varying electrical inputs.

By selectively contracting and expanding differential actuators 460a and 460b, head 16 may be tilted azimuthally to adjust the relative position of read/write elements to data tracks 102 on tape 100. Further, by simultaneously contracting one of the differential actuators 460a and 460b while expanding the other of differential actuators 460a and 460b, head 16 is rotated about its center of mass, thereby compensating for tape skew and rotating the center line of read and write elements of head 16 to data tracks 102 on tape 100.

Differential actuators 460a and 460b include, in one example, piezoelectric actuators, which may be controlled by a servo system of the tape drive to dynamically adjust head 16 to varying skew of tape 100. In other examples differential actuators 460 may include differential linear motor actuators, differential stepper motor actuators, rotary actuator geometries, or the like.

In operation, position sensors 450a and 450b sense the edge of tape 100 before and after head 16 to determine the relative skew of tape 100. In other examples, position sensors 450a and 450b may be positioned at the lower edge of tape 100, on opposing edges of tape 100, or may extend vertically to sense both edges of tape 100. A controller may compute the skew of tape 100 based on the detected positions of the tape edge at sensor 450a and 450b and differentially activate actuators 460a and 460b to rotate head 16 accordingly. Head 16 may be adjusted dynamically during read and write operations to compensate for varying tape skew. Additionally, the controller may issue warnings or shut down the drive if the tape skew exceeds predefined values of the error conditions due to damage of edges and/or magnetic/optical tracks become too severe.

The controller may carry out various methods and functions described herein through firmware, software, hardware, or any suitable combination thereof. Implementation of the various methods and functions will be apparent to those of ordinary skill in the art. Furthermore, changes to the read/write head assembly and tape path assembly in existing drive systems, such as the SDLT drive, to accommodate position sensors, such as magnetic/optical sensors, and differential actuators are generally minor and inexpensive and will be easily recognized by those of ordinary skill in the art.

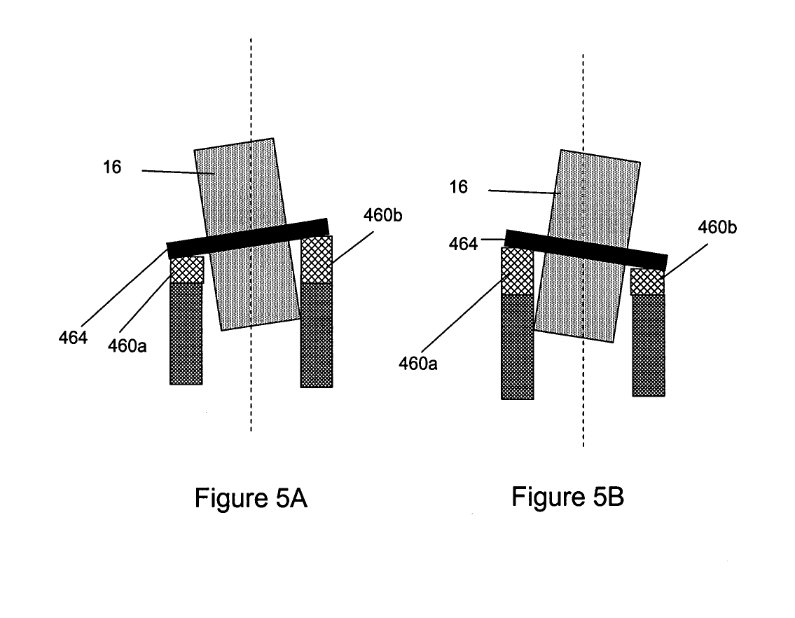

FIGS. 5A and 5B illustrate an exemplary operation of differential actuators 460 to effect a tilt or rotation of the azimuth position of head 16 about the center of mass of head 16. As shown in FIG. 5A, simultaneously contracting actuator 460a and extending actuator 460b rotates head 16 counterclockwise about the center of mass of head 16. Further, as shown in FIG. 5B, simultaneously extending actuator 460a and contracting actuator 460b rotates head 16 clockwise about the center of mass of head 16.

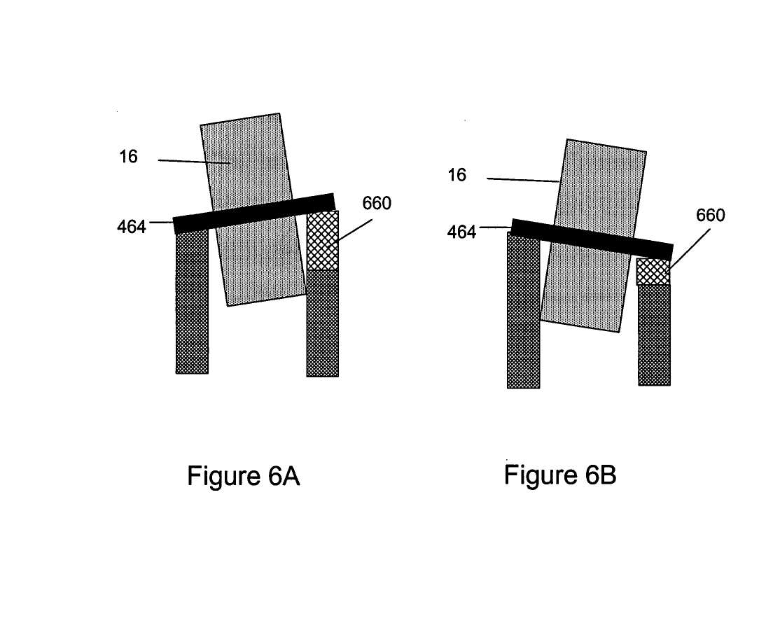

FIGS. 6A and 6B illustrate another example where the head assembly includes a single actuator 660 to effect various azimuth positions of head 16. For example, with actuator 660 fully contracted head 16 is rotated clockwise as shown in FIG. 6A. Further, with actuator 660 fully extended head 16 is rotated counterclockwise as shown in FIG. 6B.

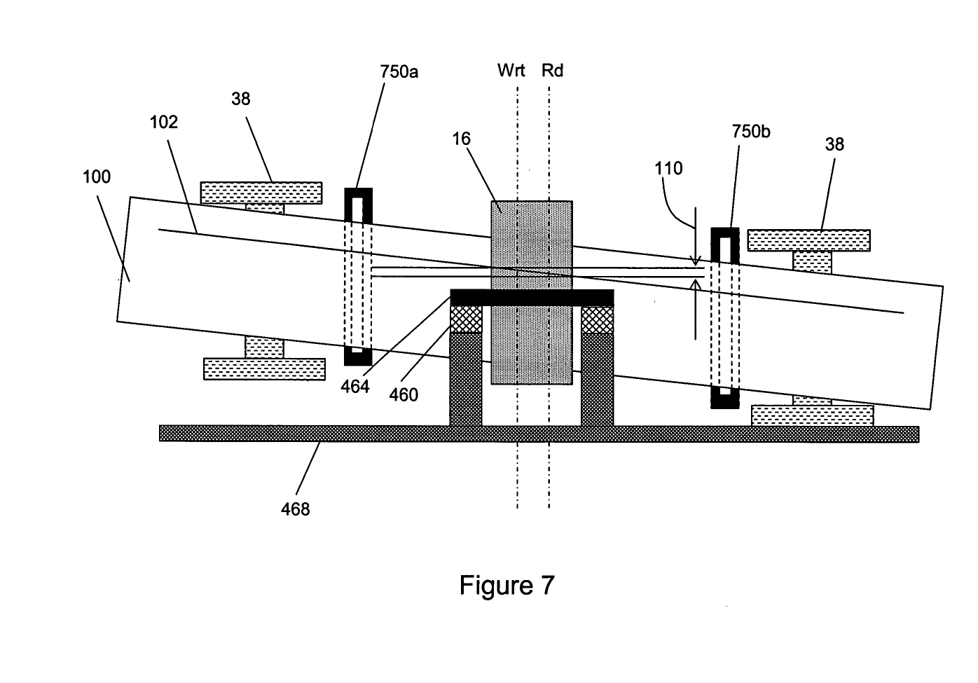

FIG. 7 illustrates a side view of another exemplary positioning system including position sensors and differential actuators for a sensing and compensating for tape skew. The exemplary system of FIG. 7 is similar to that of FIG. 4; accordingly, only those aspects that vary will be discussed in detail. As shown, position sensors 750a and 750b positioned on opposite sides of head 16 along a direction of tape transport are configured to detect both edges of tape 100. For example, positions sensors 750a and 750b may include an optical line scanner or the like. In other examples, each of position sensor 750a and 750b could include a pair of position sensors, e.g., magnetic, optical, or the like, disposed adjacent the top and bottom edge of tape 100.

Detection of both edges of tape 100 allows the servo system to compensate for tape width variations. For example, tape 100 may have regions of relatively narrow or wide width due to tape edge damage, manufacturing tolerances, or the like. If only detecting the position of one edge of tape 100, width variations may result in inaccurate skew measurements. Accordingly, width variations may be taken into account when determining tape skew by detecting the position of the top and bottom edge of tape 100 on each side of head 16.

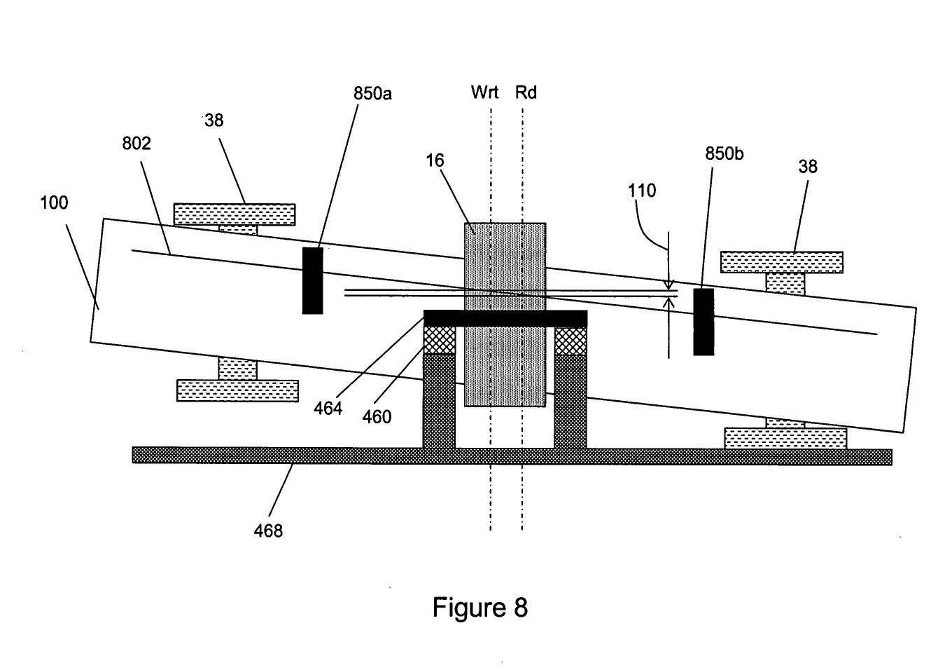

FIG. 8 illustrates a side view of another exemplary positioning system including position sensors and differential actuators for detecting and compensating for tape skew. The exemplary system of FIG. 8 is similar to that of FIG. 4; accordingly, only those aspects that vary will be discussed in detail. As shown, position sensors 850a and 850b on either side of head 16 are configured to detect a reference associated with the position of tape 100 other than the edges of tape 100. For example, positions sensors 850a and 850b are positioned to detect a reference track 802, which may include any detectable feature associated with tape 100. For example, reference track 802 may include an optically and/or magnetically detectable servo track, which may include a series of marks or continuous track. Accordingly, position sensors 850a and 850b may include suitable sensors to detect reference track 802, e.g., magnetic, optical, or the like. Additionally, a positioning system may include both edge detection sensors and reference track sensors.

The above detailed description is provided to illustrate exemplary position sensing and servo systems and methods, but is not intended to be limiting. It will be apparent to those of ordinary skill in the art that numerous modifications and variations are possible. For example, various exemplary methods and systems described herein may be used alone or in combination with various other positional and/or servo methods and systems whether described herein or otherwise including, e.g., optical or magnetic servo systems and various other head positioning systems. Additionally, particular examples have been discussed and how these examples are thought to address certain disadvantages in related art. This discussion is not meant, however, to restrict the various examples to methods and/or systems that actually address or solve the disadvantages.

1. A transducer head positioning system to compensate for skew, the system comprising:
a transducer head including read and write elements;
at least one actuator for adjusting an azimuth position of the transducer head;
a first sensor and a second sensor for sensing a reference associated with a position of a storage medium, wherein the first sensor and the second sensor are positioned on opposite sides of a centerline of the read and write elements along a direction of storage medium transport; and
a controller for adjusting the azimuth position of the transducer head in response to sensed positions of the reference by the first and second sensor.

2. The system of claim 1, wherein the reference includes at least one edge of the storage medium.

3. The system of claim 1, wherein the reference includes a magnetically detectable feature of the storage medium.

4. The system of claim 1, wherein the reference includes an optically detectable feature of the storage medium.

5. The system of claim 1, wherein the at least one actuator includes one or more piezoelectric actuators.

6. The system of claim 1, wherein the at least one actuator includes differential actuators that may be activated to adjust the azimuth of the transducer head.

7. The system of claim 6, wherein the differential actuators are selectively activated to rotate the transducer head around a center of mass of the transducer head.

8. The system of claim 1, wherein the first sensor and the second sensor are positioned adjacent guide elements on opposite sides of the read and write elements.

9. The system of claim 1, wherein the first sensor and the second sensor are positioned within the head structure.

10. The system of claim 1, wherein the controller adjusts the position of the transducer head during writing operations in response to the sensed positions of the reference by the first and second sensors.

11. The system of claim 1, wherein at least one of the first sensor and the second sensor includes an optical sensor.

12. The system of claim 1, wherein at least one of the first sensor and the second sensor includes a magnetic sensor.

13. The system of claim 1, wherein each of the first sensor and the second sensor includes a magnetic sensor and an optical sensor.

14. A method for detecting the position of a transducer head with respect to a storage medium, the method comprising:
sensing a reference associated with a position of a storage medium at a first position along a direction of storage medium transport;
sensing the reference associated with the position of the storage medium at a second position along the direction of storage medium transport, wherein the first position and the second position are on opposite sides of a centerline of a transducer head along the direction of storage medium transport; and
positioning the azimuth of the transducer head relative to the storage medium in response to the sensed first position and second position of the reference.

15. The method of claim 14, wherein the reference includes at least one edge of the storage medium.

16. The method of claim 14, wherein the reference includes a magnetically detectable feature of the storage medium.

17. The method of claim 14, wherein the reference includes an optically detectable feature of the storage medium.

18. The method of claim 14, wherein positioning further comprises activating at least one actuator to reposition the azimuth position of the transducer head.

19. The method of claim 18, wherein the at least one actuator includes one or more piezoelectric actuators.

20. The method of claim 18, wherein the at least one actuator includes differential actuators that may be activated to adjust the azimuth of the transducer head.

21. The method of claim 20, wherein the differential actuators are selectively activated to rotate the transducer head around a center of mass of the transducer head.

22. The method of claim 14, wherein the first sensor and the second sensor are positioned adjacent guide elements on opposite sides of the read and write elements.

23. The method of claim 14, wherein the controller adjusts the position of the transducer head during writing operations in response to the sensed positions of the reference by the first and second sensors.

24. The method of claim 14, wherein at least one of the first sensor and the second sensor includes an optical sensor.

25. The method of claim 14, wherein at least one of the first sensor and the second sensor includes a magnetic sensor.
